(19) United States
(12) Patent Application Publication
(10) Pub. No.: US 2025/0390271 A1
(43) Pub. Date: Dec. 25, 2025

(54) WIRELESS AUDIO DISTRIBUTION SYSTEM USING MASTER AND SLAVES AND CONNECTION METHOD OF THESE SYSTEMS

(71) Applicant: DEBONES DOS REIS, PAULINIA (BR)

(72) Inventor: DEBONES DOS REIS, PAULINIA (BR)

(21) Appl. No.: 18/915,377

(22) Filed: Oct. 15, 2024

(30) Foreign Application Priority Data
Jun. 21, 2024 (BR) 1020240127323

(51) Int. Cl. G06F 3/16

(52) U.S. Cl. CPC G06F 3/165

(57) ABSTRACT

This patent application deals with a wireless audio distribution system, and means of connecting these systems via Bluetooth, with a master transmitter system and one or more slave receiver systems for this audio distribution, so as to generate a synchronized audio transmission and without the need for wires. This system is intended for use in car audio systems, more specifically in audio synchronization for multiple audio players.

### INVENTION FIELD

Embodiments provided herein relate to a wireless audio distribution system, and methods for connecting these systems via Bluetooth, with a master transmitter system and one or more slave receiver systems for this audio distribution, so as to generate a synchronized audio distribution without the need for wires. This system is intended for use in car audio systems, more specifically in audio synchronization for multiple audio players.

### BACKGROUND OF THE INVENTION

In the area of audio distribution between various audio reproducing devices, such as speakers, it is necessary not only to connect but also to synchronize these devices so that sound is not delayed between the different devices, deteriorating the sound in the application environment. There are ways of connecting these multiple audio reproducing devices so that they are synchronized, either via the use of cables or by generating an audio transmission via radio frequency, as in the transmissions used by FM radio stations. When using cables for audio transmission, however, there is noise generated due to potential difference problems between cables, problems due to the quality of these cables and connections or interference between them, as well as possible physical damage to the cables when installed in busy places, thus requiring constant replacement. Another important point is that the use of cables is difficult to sort out and install, depending on the number of cables to be used, and this poor mobility is another negative point in the event of design changes. FM radio broadcasting is illegal without public authorization, and audio quality is compromised due to the transmission bandwidth and noise problems that are very common in radio distribution. This broadcast is also public and any listener can tune into the correct frequency to hear the broadcast.

Therefore, this invention aims to provide an apparatus and method for connecting various systems with audio reproducing equipment via Bluetooth technology, with a system called the master and others its slaves, thus providing a simple and effective apparatus and method for synchronizing and configuring these systems that is not covered by the prior art.

JP2020109989, entitled “RING NETWORK OF MULTIPLE SPEAKERS” published on Jul. 16, 2020, discloses: “A method is provided to form a set of ring networks of multiple Bluetooth speakers. SOLUTION: In a Bluetooth speaker ring network including multiple Bluetooth speakers and multiple audio devices connectable to one of the Bluetooth speakers, a method includes a step of adding the upstream Bluetooth speaker address of the multiple Bluetooth speakers to each configurable speaker registration unit of the multiple Bluetooth speakers, a step of adding the downstream Bluetooth speaker address of the multiple Bluetooth speakers to each configurable speaker registration unit of the multiple Bluetooth speakers, and a step of connecting a sound source to one of the multiple Bluetooth speakers”.

It should be noted that in this document Bluetooth speakers with ring topology are used, where each device transmits information to its neighbor until this information reaches the last device on the network, differing from the use of masters and slaves of this patent application, which falls within a star-type topology, in which a single device transmits the information simultaneously to several devices on the network.

U.S. Pat. No. 20,233,70774, entitled “BLUETOOTH SPEAKER CONTROL METHOD AND SYSTEM, STORAGE MEDIUM, AND MOBILE TERMINAL” and published on Nov. 16, 2023, discloses: “A Bluetooth speaker control method and system, a storage medium and a mobile terminal are disclosed. The method includes constructing multiple sound channels by means of an audio manager in a system structure of a mobile terminal; then constructing a multiple of virtual Bluetooth audio transmission model protocol channels by means of a Bluetooth protocol stack of the mobile terminal; and correspondingly connecting the multiple virtual Bluetooth audio transmission model protocol channels to multiple external Bluetooth speakers, so that the audio information in multiple sound channels is reproduced by means of multiple Bluetooth speakers. In addition, the method performs synchronous detection on the multiple Bluetooth speakers to avoid delay of the audio signals from the multiple Bluetooth speakers”.

It is noted that this document shows a form of Bluetooth transmission from different audio channels to different Bluetooth speakers through a single mobile terminal, where only the mobile terminal is configured as an audio transmitter. In addition, there is no means of configuring any device as master or slave as in this patent application, which allows any device to assume the task of transmitter or receiver.

### SUMMARY

As main objectives and advantages obtained through the invention shown herein, we have the following points:
The use of Bluetooth allows direct and private connections between the transmitter and receivers. This means that the audio or data transmission is specific to the paired devices, without interference from external sources, and can be customized for the connected systems. The Bluetooth communication protocol is used for audio, minimizing interference with other wireless systems and providing a secure connection with the possibility of encryption;
Transmission via Bluetooth uses the 2.4 GHz free band, unlike FM radio transmissions, which are regulated by government agencies and require authorization. This makes Bluetooth a more affordable option for personal and small-scale business use.

An audio distribution system that includes a master and slave system for transmitting an audio source from the master system to one or more slave systems for reproducing this audio in audio reproduction devices, in a synchronized manner using bluetooth technology. The system has a control interface for defining the tasks of each system and warnings of the operating modes, which are operated by buttons or microcontroller or via application.

### DESCRIPTION OF FIGURES

The invention will be described below in details, and for a better understanding, references will be made to the attached drawings in which they are represented:

FIG. 1: Diagram showing a system with its constituent elements and their connections;

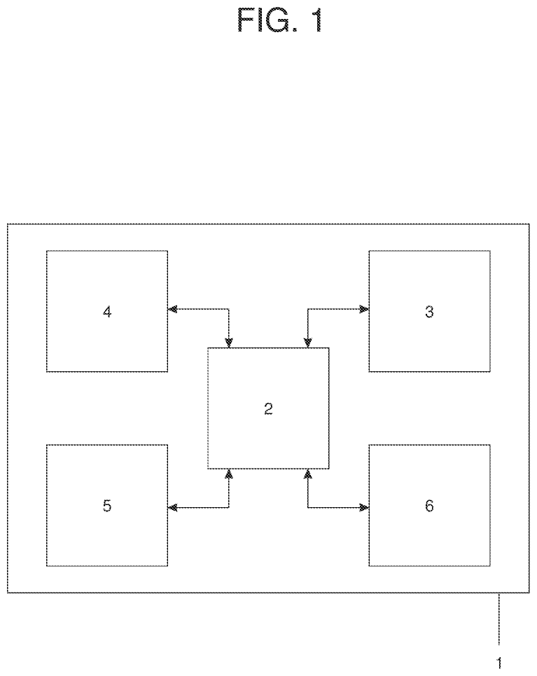

FIG. 2: Diagram showing interface of the first method of the system and the connection of the interface elements;

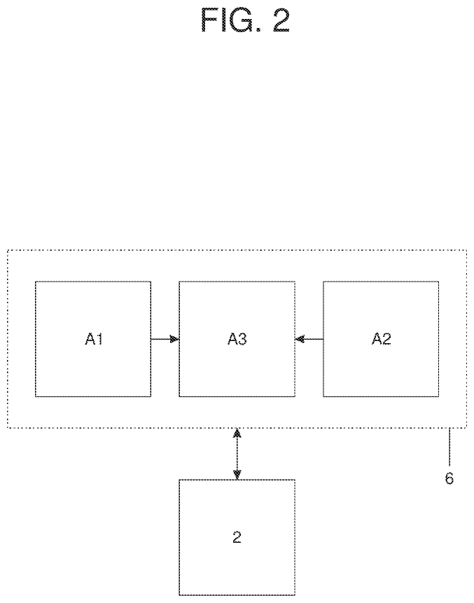

FIG. 3: Diagram showing interface of the second method of the system and the connection of the interface elements, also showing the use of address for connection of systems;

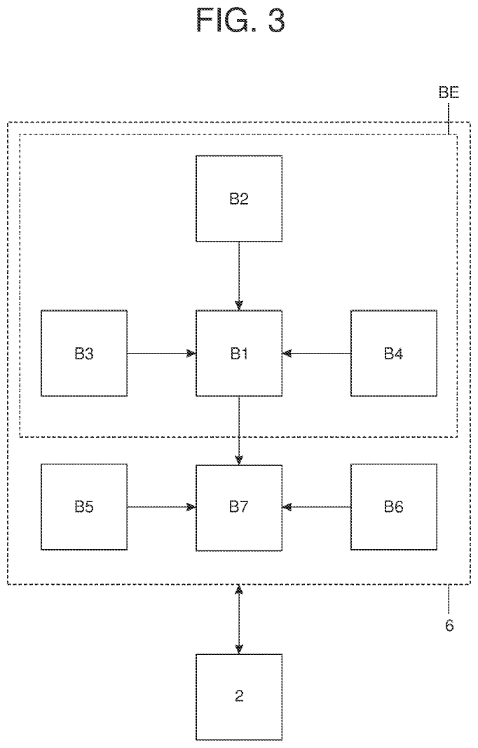

FIG. 4: Diagram showing connection of multiple systems, with one master and several slaves.

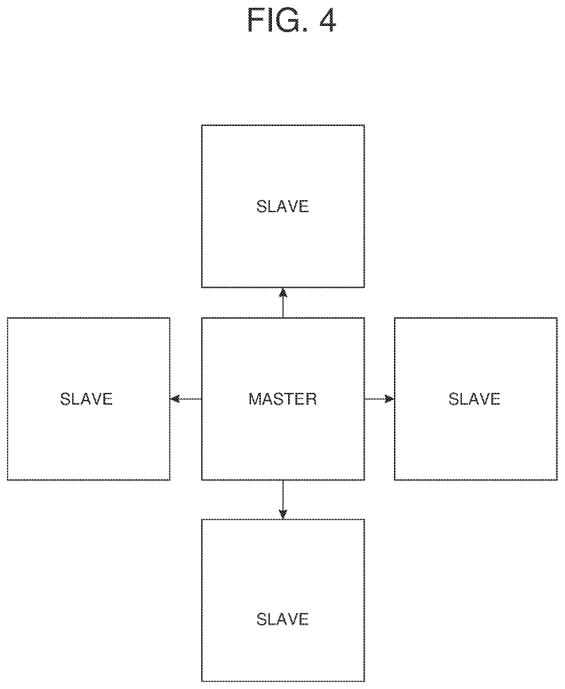

### DETAILED DESCRIPTION OF THE INVENTION

A wireless audio distribution system using master and slaves and methods for connecting same are provided. In one embodiment, the systems includes a system (1),

with multiples of these systems (1) in communication with each other for the audio transmission, common to the systems (1) called master and others called slaves, for the audio connection and synchronization of these systems (1). A master system (1) can connect to multiple slaves, but a slave system (1) can connect to only one master.

The system (1) can include a bluetooth module, configured to perform communication between the different systems (1), an interface (6) that controls the system (1) through direct communication with the Bluetooth module or through a microcontroller or application, selecting whether the system (1) will act as master or slave, and initiating the connection between these systems (1), in addition to showing the current configuration of the system (1), such as whether it is acting as master or slave, through the use of LEDs, LCD or OLED screen, or even by application. The interface (6) also has a series of keys, whether physical or working port, used to configure the system (1). It can also have an LCD screen and microcontroller to better visualize the information. The system (1) also has an audio input from an audio source (5), which can be, for example, a car radio, a sound mixer or even a Bluetooth cell phone, and an audio output for audio reproduction equipment (4), such as audio amplifiers and speakers. If the system (1) acts as a master, it receives this audio from the audio source (5) and transmits it to all slave devices connected to the master and also to its own output to the audio reproduction equipment (4). If the system (1) acts as a slave, it receives the audio from the master and transmits it to the output of its respective audio reproduction equipment (4) in a synchronized manner, so that both the slaves and the master have the outputs with the same delay time defined by the Bluetooth communication protocol.

In a first method, a connection is made between the system (1) intelligently, with the interface (6) having a master key (A1) to configure the system as a master, a slave key (A2) to configure the system as a slave, and a link key (A3) to initiate the connection of the system (1) with other nearby systems (1) in the selected configuration.

In a second method, the system (1) connects via address (BE), with the interface (6) showing this address (BE) via the display (B1) in list format and having keys for changing the address (BE), with a key (B2) for selecting an address higher up in the list of addresses found, a key (B3) for selecting an address lower down in the list of addresses found, and an entry (B4) for confirming the address (BE) selected. The list also has an option to directly enter a known address (BE), using the keys to increase a digit (B2), decrease a digit (B3), confirm a digit (B4) or confirm a connection if it is in the last digit and return a digit (B5) or return the list if it is in the first digit. Also located on the interface (6) are master key (A1) to configure the system as master, slave key (A2) to configure the system as slave, and link key (A3) to initiate the connection of the system (1) with other nearby systems (1) in the selected configuration and through the selected address (BE).

In both methods, the interface (6) itself may be made available by mobile device application, with this application connected to the system (1) by the Bluetooth module (3), and with the interface keys (6) being controllable by the application and with the interface information (6) also made available in the application.

### SYSTEM CONNECTION METHOD

To use the first method of the system (1), separate systems (1) are configured as master and another as slave, through the master key (A1) to configure a system as master and slave key (A2) to configure a system as slave. After this, the link key (A3) is pressed in both systems (1), causing these systems (1) to search for other systems (1) nearby, thus connecting through the Bluetooth module (3). After this initial connection, more systems (1) can connect in the same way as slaves of the initial master system

(1) by the same procedure used by the initial slave system (1).

In a second method of the system (1), the system (1) performs the connection via addressing (BE), with the interface (6) showing this address (BE) via display (B1) in list format and having keys to change the address (BE), with a key (B2) to select an address above in the list of found addresses, a key (B3) to select an address below in the list of found addresses, and an entry (B4) that allows confirmation of the selected address (BE). The connection can be made also by option to directly enter a known address (BE), using the keys to increase a digit (B2), decrease a digit (B3), confirm a digit (B4) or confirm a connection if it is in the last digit, returning a digit (B5) or returning the list if it is in the first digit. After this, a system is configured (1) as master via key (B5) to configure the connection as master and a system (1) as a slave via key (B6) to configure the connection as a slave (B6), and then the link keys (B7) are pressed in the systems (1), with these systems (1) then searching for other systems (1) nearby, thus connecting through the Bluetooth module (3) if they both have the same address (BE). After this initial connection, more systems (1) can connect in the same way as slaves of the initial master system (1) by the same procedure used by the initial slave system (1) and using the same address (BE) of the initial connection.

After the connection, in both methods, the audio coming from the audio input of an audio source (5) of the master is transmitted to the slaves, with all systems (1) connected emitting this audio through their respective audio output to an audio reproduction equipment (4), with this audio being automatically synchronized by the Bluetooth protocol that uses a small delay for the audio output to an audio reproduction equipment (4) of each system (1), both the slaves and the master, so that all systems (1) are synchronized and release this audio simultaneously.

In the foregoing discussion and in the claims that follow, the terms “including” and “comprising” are used in an open-ended fashion, and thus should be interpreted to mean “including, but not limited to.” The phrase “consisting essentially of” means that the described/claimed composition does not include any other components that will materially alter its properties by any more than 5% of that property, and in any case does not include any other component to a level greater than 3 mass %. The term “or” is intended to encompass both exclusive and inclusive cases, i.e., “A or B” is intended to be synonymous with “at least one of A and B,” unless otherwise expressly specified herein. The indefinite articles “a” and “an” refer to both singular forms (i.e., “one”) and plural referents (i.e., one or more) unless the context clearly dictates otherwise.

Other embodiments provided herein can include any one or more of the following numbered embodiments 1 through 6:
Embodiment No. 1: wireless audio delivery system utilizing master and slaves, a system (1) characterized in that it consists of a bluetooth module (3), an output to an audio reproduction equipment (4) and an input from an audio source (5); the system (1) has configuration capability either as master or as slave, so that the input from the audio source (5) of the master is transmitted wirelessly to one or more slave devices, in a synchronized manner, and this audio received by the slaves is transmitted to their respective outputs to an audio reproduction equipment (4).
Embodiment No. 2: The system, according to embodiment 1, characterized in that the system (1) has an interface (6) with configuration and automatic connection keys being a master key (A1), a slave key (A2) and a link key (A3).
Embodiment No. 3: The system according to embodiments 1 and 2, characterized in that the system (1) has an interface (6) with microcontroller and display (B1) showing the address (BE), keys to change the address (BE), key (B2) to select an address above in the list of found addresses, key (B3) to select an address below in the list of found addresses, input key (B4) that allows confirmation of the address (BE) selected; direct typing option of a known address (BE), with keys to increase a digit (B2), decrease a digit (B3), confirm a digit (B4) or confirm connection if it is in the last digit and return a digit (B5) or return the list if it is in the first digit, master key (A1), slave key (A2) and link key (A3).
Embodiment No. 4: The system according to embodiments 1, 2 and/or 3, characterized in that a mobile device application connects to the system (1) by the Bluetooth module (3), with in this application then the interface (6) becoming available in the application, with the interface keys (6) being controllable by the application and with the interface information (6) made available in this application.
Embodiment No. 5: A method for connecting these systems, using the system shown in claims 1 and 2, characterized in that they configure separate systems (1) one as master and the other as slave, with this carried out using the master key (A1) to configure a system as master and slave key (A2) to configure a system as slave; after this, the link key (A3) is pressed in both systems (1), with these systems (1) then searching for other systems (1) nearby, thus connecting them through the Bluetooth module (3), and more systems (1) can connect in the same way as slaves of the initial master system (1) by the same procedure used by the initial slave system (1); the audio coming from the audio input of an audio source (5) of the master is transmitted to the slaves, with all systems (1) connected emitting this audio through their respective audio output to an audio reproduction equipment (4), with this audio being automatically synchronized by the Bluetooth protocol that uses a small delay for the audio output to an audio reproduction equipment (4) of each system (1), both the slaves and the master, so that all systems (1) are synchronized and release this audio simultaneously.
Embodiment No. 6: The system connection method of these systems, using the system shown in claim 3 and according to claim 5, characterized in that the system (1) performs the connection via addressing (BE), with the interface (6) showing this address (BE) via display (B1) in list format, having keys to change the address (BE), with key (B2) to select an address above in the list of found addresses, key (B3) to select an address below in the list of found addresses, and input key (B4) that allows the confirmation of the selected address (BE); has a direct typing menu option of a known address (BE), through the keys to increase a digit (B2), decrease a digit (B3), confirm a digit (B4) or confirm connection if it is in the last digit, and return a digit (B5) or return the list if it is in the first digit; are also located on the interface (6) master key (A1) to configure the system as master, slave key (A2) to configure the system as slave, and link key (A3) to start connecting the system (1) with other systems
   (1) in the selected configuration and through the selected address (BE); more systems (1) can connect in the same way as slaves of the initial master system (1) by the same procedure used by the initial slave system (1) and using the same address (BE) of the initial connection.

The features of the invention disclosed in the above description, the claims and the drawings can be important both on their own and also in any desired combination for the implementation of the invention in its various embodiments.

1. A system for wireless audio delivery system utilizing master and slaves, comprising:
a Bluetooth module,
an output to an audio reproduction equipment, and
an input from an audio source, wherein the system has configuration capability either as master or as slave, so that the input from the audio source of the master is transmitted wirelessly to one or more slave devices, in a synchronized manner, and this audio received by the slaves is transmitted to their respective outputs to an audio reproduction equipment.

2. The system of claim 1, wherein the system has an interface with configuration and automatic connection keys being a master key, a slave key and a link key.

3. The system of claims 2 wherein the system has an interface with microcontroller and display (B1) showing the address (BE), a first key to change the address (BE), a second key to select an address above in the list of found addresses, a third key to select an address below in the list of found addresses, an input key that allows confirmation of the address (BE) selected; direct typing option of a known address (BE), with keys to increase a digit (B2), decrease a digit (B3), confirm a digit (B4) or confirm connection if it is in the last digit and return a digit (B5) or return the list if it is in the first digit, master key, slave key and link key.

4. The system of claim 1, wherein a mobile device application connects to the system by the Bluetooth module, with in this application then the interface (6) becoming available in the application, with the interface keys being controllable by the application and with the interface information made available in this application.

5. A method for connecting a wireless audio delivery system utilizing master and slaves, comprising:
configuring separate systems, one as master and the other as slave, with this carried out using a master key to configure a system as master and a slave key to configure a system as slave; after this, the
pressing a link key in both systems,
searching for other systems nearby, thus connecting them through the Bluetooth module, and
connecting or more systems in the same way as slaves of the initial master system by the same procedure used by the initial slave system, the audio coming from the audio input of an audio source of the master is transmitted to the slaves, with all systems connected emitting this audio through their respective audio output to an audio reproduction equipment, with this audio being automatically synchronized by the Bluetooth protocol that uses a small delay for the audio output to an audio reproduction equipment of each system, both the slaves and the master, so that all systems are synchronized and release this audio simultaneously.

6. A method for connecting a wireless audio delivery system utilizing master and slaves, comprising:
using the system of claim 3 and according to the method claim 5, wherein:
the system performs the connection via addressing (BE), with the interface showing this address (BE) via display (B1) in list format, having keys to change the address (BE), with key to select an address above in the list of found addresses, key to select an address below in the list of found addresses, and input key (B4) that allows the confirmation of the selected address (BE); has a direct typing menu option of a known address (BE), through the keys to increase a digit (B2), decrease a digit (B3), confirm a digit (B4) or confirm connection if it is in the last digit, and return a digit (B5) or return the list if it is in the first digit; are also located on the interface (6) master key (A1) to configure the system as master, slave key (A2) to configure the system as slave, and link key (A3) to start connecting the system (1) with other systems in the selected configuration and through the selected address (BE); more systems can connect in the same way as slaves of the initial master system (1) by the same procedure used by the initial slave system and using the same address (BE) of the initial connection.
